(19) United States
(12) Patent Application Publication
(10) Pub. No.: US 2024/0221097 A1
(43) Pub. Date: Jul. 4, 2024

(54) METHODS AND AUTOMATED SYSTEM OF REAL TIME VIRTUAL CONNECTION TO LEGAL REPRESENTATION

(71) Applicant: TIWUANA HARRIS, Indianapolis, IN (US)

(72) Inventor: TIWUANA HARRIS, Indianapolis, IN (US)

(21) Appl. No.: 18/149,280

(22) Filed: Jan. 3, 2023

(51) Int. Cl. G06Q 50/18

(52) U.S. Cl. CPC G06Q 50/18

(57) ABSTRACT

A method and system including receiving, at one or more processors, accessing a registration database to determine one or more personal computing devices. The method includes detecting at least one of the one or more personal computing devices, and generating an activation request signal for transmission to at least one personal computing device. A method and system responsive to receiving an acceptance signal from at least one personal computing device, the method includes wirelessly communicating with real-time virtual legal representation to ensure the rights of the individual are exercised for all individuals without bias.

### CROSS-REFERENCE TO RELATED APPLICATION

This U.S. Non-Provisional patent application claims priority to U.S. Provisional Application No. 63/295,557 filed 31 Dec. 2021 to the above named inventor, the disclosure of which is considered part of the disclosure of this application and are hereby incorporated by reference in their entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

This invention relates generally to method and automated systems of real-time virtual connection to legal representation, and more particularly to a platform on a mobile device for individuals to request legal representation in interactions by law enforcement. The platform on a mobile device is a mobile application with an automated system that allows real-time virtual connection with legal representation to ensure the rights of the individual in interactions with law enforcement are exercised for all individuals without bias.

### BACKGROUND

The problem of potential violence can exist between any authority member and any individual, but mutual distrust and unnecessary confrontation between individuals and authorities can be particularly problematic. The terms “law enforcement” and “officers” used herein refers to authorities or persons acting in a position of authority, and may include but are not limited to individuals representing law enforcement agencies (e.g., police, DEA, sheriffs, state troopers, FBI, housing, ICE, etc.). The term “individuals” used herein refers to civilians or others who do not belong to these groups of persons that are in positions of authority. There are various explanations on why this problem exists and whether it has increased in frequency and magnitude, or whether it has just become more known to the public as a result of social media and video tools embedded in mobile devices. In any event, it is clear that there is a need for an application to ensure law enforcement for all individuals, without bias.

It is known that authorities have been accused of profiling, implicit bias, and/or outright prejudicial behavior. All people have prejudices to some degree, and some people have deeply ingrained prejudicial beliefs that exist for reasons that run deeper than learned conditioning. And, of course, prejudice and prejudicial treatment is not limited to any single subgroup. There are individual characteristics that may cause people to treat others differently, such as race, gender, age (teenagers, seniors), religion, weight, or the like. Even disregarding bias towards specific groups of individuals, when individuals are temporarily detained by authorities, it may be an inherently unpleasant and or near-death experience for the individuals involved, potentially invoking stress, anxiety, fear, intimidation, and embarrassment.

A common problematic type of interaction takes place between an authority and an individual the authority member has stopped (e.g., “pulled over”) for a temporary traffic stop or detention. Distrust and fear may be felt by both parties as they engage in a “blind” interaction where neither party has communicated nor beheld one another visually before they are literally and suddenly face-to-face. This is a dangerous type of situation, and with the proliferation of weapons, authorities have good reason for having feelings of anxiety and fear as they approach a vehicle with unknown occupants. Due to the very nature of a traffic stop (which involves a face-to-face first interaction with no previous communication or visual assessment), an authority may approach the vehicle with his/her hand on a gun to be cautious in case of a hostile occupant. This action, if perceived by the individual of the vehicle being approached by the unknown authority, can exacerbate the fear and anxiety felt by the individuals within the vehicle. With fear, tension, and mistrust on both sides, the situation can be tense, and behaviors can be unpredictable and escalate quickly.

It is recognized that interactions between authorities and individuals which start out in an ordinary manner can escalate very quickly, and sometimes rendering a violent conclusion. Any conversation that takes place between two individuals may start in a friendly tone, but, given the “wrong” chemistry, language used, facial expressions, body posturing and/or tone of voice, the conversation or situation can quickly take a turn for a violent outcome. In a situation where a law enforcement officer has pulled over an individual, there is an opportunity for this kind of escalation to occur.

Mobile applications (“Apps’) for a user's Smartphone or other mobile computing devices (e.g., iPad, Kindle, etc.), have gained popularity and are known in the art to improve their lives through new programs and devices. For example, there are a number of Apps related to personal security and safety that are available for the iPhone, and some for Android. Some of these include: Bsafe, Guardly, Watch Over Me, StaySafe, OnWatch, and Circle of 6. Each of these Apps provide some narrow safety enhancing functionality, which typically is directed to alerting family members and/or friends about a perceived threat or an ongoing unsafe situation. Some of these Apps include GPS tracking and transmitting of the user's location, and others include automatic sending of emergency notifications if the cell phone's user fails to reach their entered destination within the allotted time period.

A need remains for a platform for authorities to interact with individuals safely and fairly, providing an interaction that is as “blind” as possible from prejudicial treatment with a reduced opportunity for escalation.

### BRIEF SUMMARY OF THE INVENTION

In one aspect of the invention, the next-generation platform of the present disclosure may incorporate similar functionality to the Apps related to personal security and safety, but the next-generation platform advantageously includes features that contribute to the individual's safety and situational awareness with law enforcement, and the ability to better interact with authorities to further contribute to such safety and security for individuals.

In one aspect of the invention, the present invention may be in the form of a mobile application or a device specific native application that is directed to enhancing safety and security to the individual, through the use of a plurality of different modules.

The presence of a mobile application with an automated system will prevent hostile altercations that could potentially lead to fatal outcomes. The mobile application with an automated system is used when an individual is in the presence of law enforcement.

Embodiments of the present disclosure generally relate to methods and automated systems of real-time virtual connection to legal representation to manage the detention of individuals by authorities, and more specifically to manage the interactions between individuals and law enforcement during interactions.

In a further aspect of the invention, a system is provided that includes one or more processors and one or more data storage media operatively connected to the one or more processors.

In additional aspects of the invention, a method is provided that includes receiving, at one or more processors, a virtual dispatch that is uniquely associated with an individual's device or a legal representative's device, and accessing a registration database to determine one or more personal computing devices that are registered. The method includes detecting one or more personal computing devices, and generating an activation request signal for transmission to at least one personal computing device.

In one or more embodiments the method includes wirelessly communicating information to legal representation to address interactions with law enforcement.

In one or more embodiments the method includes the one or more processors contacting one or more legal representatives in proximity to the personal computing device.

In one or more embodiments, one or more processors in the method and the system described above are configured to detect that at least one of the one or more personal computing devices is located proximate to legal representation by virtual dispatch, and generates an activation request signal for transmission to at least one personal computing device proximate to the legal representatives computing devices.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a flow chart of a method for managing the interactions between individuals and legal representatives.

FIG. 2 is a block diagram illustrating a mediation system formed in accordance with one or more embodiments.

FIG. 3 is a schematic illustration of a mobile application including features of the mobile application according to one embodiment of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

All Appendices, publications, patents and patent applications cited herein, whether supra or infra, are hereby incorporated by reference in their entirety to the same extent as if each individual publication, patent or patent application was specifically and individually indicated to be incorporated by reference.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The embodiments described herein address the needs described above. For example, one or more embodiments described herein provide a system and method for increasing safety and mitigating violence between authorities and the individual. For authorities, the system and method described herein provide the advantages of increasing safety and reducing potentially fatal outcomes. For individuals, the system and method can reduce, and potentially eliminate, the influence of bias, and can result in less fear, anxiety, intimidation, and/or risk of violence experienced during interaction. The next-generation platform described herein is comprehensive, but it is understood that the system and method can also be followed in part.

Although one or more embodiments described herein are directed to the situational interaction between authority (e.g., law enforcement officers) and individuals, the next-generation platform is not so limited to traffic stops involving vehicles and can also be applied to other types of interactions between individuals and authorities. For example, some other potential applications of the next-generation platform described herein may include situations in which authority members have interactions with individuals at a protest.

For example, the system and method described herein, or at least portions thereof, can be applied to increase safety and reduce the influence of prejudice when law enforcement personnel visit a building, such as a dwelling (e.g., house, apartment, or the like), for a home visit, to investigate suspicious activity, to execute a search warrant, to execute an arrest warrant on a civilian within the building, or the like.

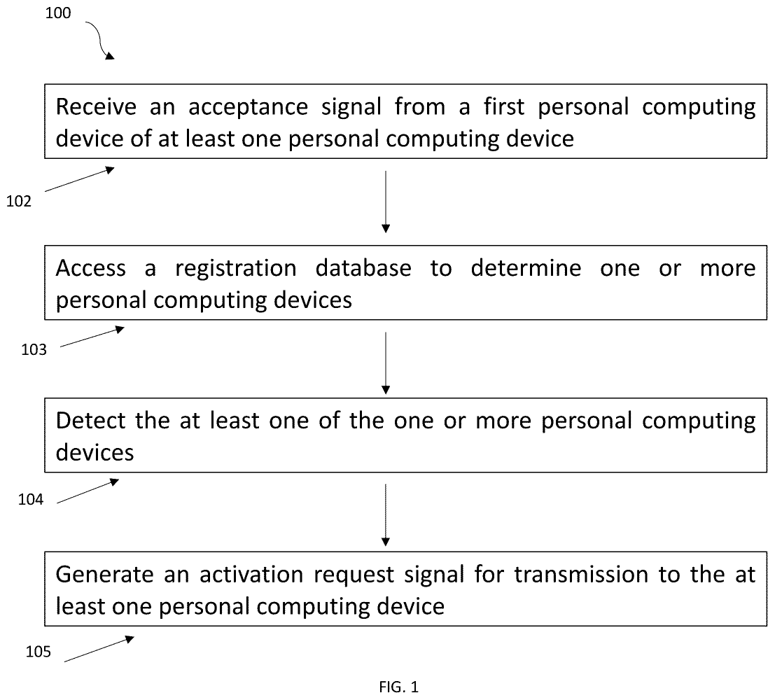

FIG. 1 is a flow chart of a method 100 for managing interactions between individuals and legal representatives. Certain embodiments described herein provide a mechanism for enabling remote communications between an authority member and an individual within a vehicle or a building prior to (or instead of the two parties meeting face-to-face).

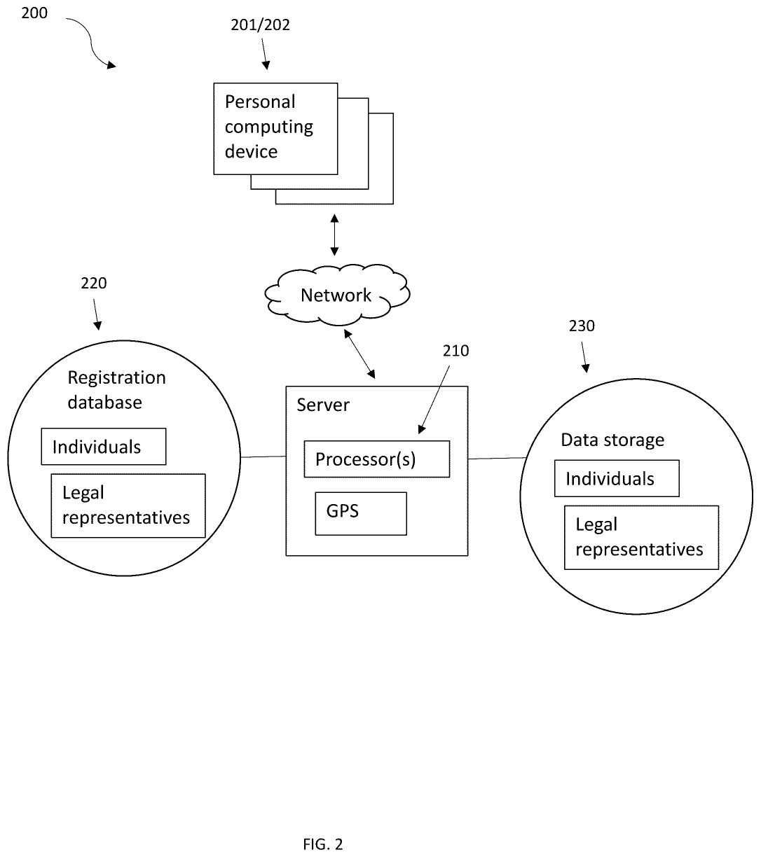

FIG. 2 is a block diagram illustrating a mediation system 200 formed in accordance with one or more embodiments. The mediation system 200 includes one or more processors and one or more data storage media operatively connected to the one or more processors. The one or more data storage media 230 stores a registration database 220 and program instructions accessible by the one or more processors. Responsive to execution of the program instructions, the one or more processors are configured to access the registration database 220 responsive to virtual dispatch that is uniquely associated with the individual or the legal representative to determine one or more personal computing devices that are registered.

By establishing a line of communication, the authority member can set expectations and the legal representative can represent through real-time virtual connection, thereby reducing uncertainty and tension of engagement between the authority member and the individual.

In one or more embodiments the registration database 220 will have a profile of the individual that will contain personal information such as: name, address, phone number, email, medical conditions will be visible to at least one or more legal representatives.

In one or more embodiments the registration database 220 will have a profile of the legal representatives in proximity to the personal computing device that will contain name, phone number, email, firm or school visible to at least one or more individual personal computing devices.

In one or more embodiments, a non-transitory computer readable storage medium is provided that has computer executable code to access a registration database in response to the mobile application upon receipt of an acceptance signal at 102. At 103 the registration database is accessed to determine one or more personal computing devices are registered with the mobile device in the registration database. At 104, the computer readable storage medium has computer executable code to detect that at least one of the one or more personal computing devices is based in a proximity of the at least one personal computing device to a location of an legal representative, and, at 105, to generate an activation request signal for transmission to the at least one personal computing device. Responsive to receiving an acceptance signal from a first personal computing device of the at least one personal computing device to a legal representative, the computer executable code is configured to wirelessly communicate information to said first personal computing device.

In one or more embodiments, a method is provided that includes receiving, at one or more processors, an initiation signal from a first personal computing device at 102, and determining a location of the first personal computing device at 103. The method includes detecting a legal representative that is proximate to the first personal computing device based on the location of the first personal computing device at 104, and generating an activation request signal for transmission to an authority computing device associated with the legal representative at 105.

In one or more embodiment, the system and the method are responsive to receiving an acceptance signal from a first personal computing device of at least one personal computing device at 102, the method includes wirelessly communicating information to said first personal computing device, wherein the system and the method are responsive to receiving an acceptance signal from the legal representative computing device, the method includes wirelessly communicating information between said legal representative computing device and said first personal computing device.

In one or more embodiment, the system and the method are responsive to receiving an acceptance signal from a first personal computing device of the at least one personal computing device proximate to one or more legal representative at 102, the one or more processors 210 are configured to wirelessly communicate with said first personal computing device.

A technical effect is reduced threat of violence between the authority member and the individual(s) because of the established real-time wirelessly communication with a legal representative. Another technical effect of the embodiments is a reduction in uncertainty and speculation about the facts of the interaction between the authority member and the individual during the interaction.

The following describes a system and method for managing communications or

“mediating” interactions between authorities and individuals. Before legal representatives and individuals meet face-to-face, it is a further advantage of the next-generation platform to facilitate establishing legal representation through real-time virtual connection by using a consumer method of payment one-time fee, which can be charged once a call is completed on an individual's personal computing device.

In one embodiment, the legal representative may receive a form of payment from the individual personal computing device, through wireless communication information, once a call is completed. The individual can download the mobile application onto the individual's personal computing device via apple store for iPhone, or market place for androids, with required Set-up Fees such as $25.00 for individual, $40.00 for a couple, and $74.99 for a Family of Four. The individual will pay a monthly fee of $4.99. Sample charges for a call upon completion are as follows: $50.00 between the hours of 8 am-9 pm Mon-Fri, $74.99 between the hours of 9 pm-7:59 am Mon-Fri, and $100.00 all day Saturday and Sunday.

The system and method further generate agreements, wherein an agreement is configured to be signed by the individual and/or by the legal representative. In one embodiment a disclosure stating agreement of compliance and policies of the usage of the mobile web application is transmitted to the individual for signing, and a contractual agreement agreeing to payment of services, legal representative's services, and responsibilities as Counsel is transmitted to the legal representative for signing. The signing of these agreements enables the individual and the legal representative to solve situations without the need to meet face-to-face, or to establish prior agreements prior to meeting face-to-face. For instance, in the case of a routine traffic stop for a minor traffic infraction, the system and method described herein may enable a legal representative and authority to manage the interaction without having a face-to-face interaction between an individual and an authority member.

The system 200 may include or represent a mobile web application that utilizes processors 210. Registering a personal computing device, such as a mobile phone or tablet computer 201/202 by downloading the mobile web application 220 is the first step of the registration process 101, by at least one individual and at least one legal representative. During the registration process 101 individuals and legal representatives will be prompted to input personal information (i.e. name, address, phone number, email, medical conditions) onto the individual's personal computing device 201 or professional information (i.e. title, license registration number, address, phone number, email) onto the legal representative's personal computing device 202.

The personal computing devices 201/202 may be cell phones, but also could include tablet computers, laptop computers, digital cameras, video game consoles, personal digital assistant devices, or other devices having the hardware and software to enable the communications described herein. Once a personal computing device associated with a legal representative is identified 202, one or more processors 210 thereof reaches out to these devices 202. The processors 210 may utilize location—based services (e.g. GPS) on the personal computing devices 201/202 to receive location data 203/204 corresponding to the personal computing devices 201/202, and may compare the locations 203/204 of the personal computing devices to the location of the legal representatives computing devices to determine which of the registered personal computing devices, if any, are within a designated proximity of the legal representative. GPS and additional information about the locations of the personal computing devices can be used to refine the match with the registered legal representative.

In at least one embodiment, the legal representative initiates communication to the registered individual(s) by transmitting a signal from the device 202, via the mobile web application on the personal computing device, to device 201 (e.g., computer or laptop). The legal representative may “initiate communication” by making a selection on the mobile web application in the personal computing device 202 at step 102.

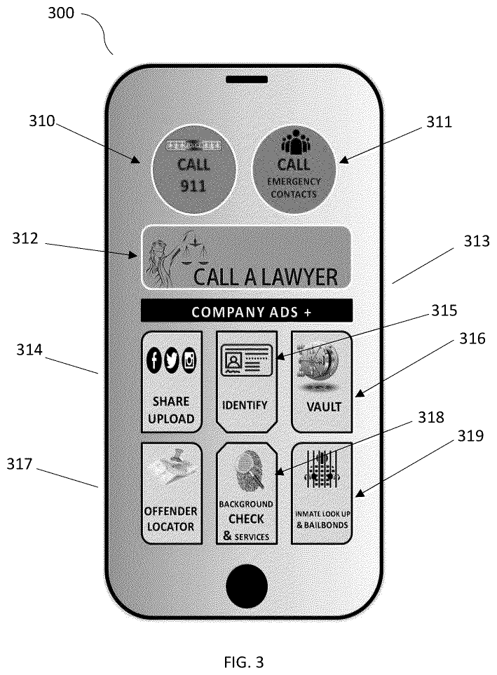

FIG. 3 illustrates a mobile application 300 as one or more embodiments, including systems and methods for wirelessly connecting individuals to emergency services or to individual's contacts or to legal representatives, including several options from Call 911, Call Emergency Contact, Call a Lawyer, Share Upload, Identify, Vault, Offender Locator, Background Check & Services, Inmate Lookup & Bailbonds. The mobile application also includes a Company Ads banner. It is understood that this web application may include additional screens or a different graphical user interface in order to provide similar options.

The mobile application 300, comprises module 310, which when held for 3 seconds will automatically call emergency services, such as by dialing 911.

Mobile application 300 comprises module 311, which when held for 3 seconds will perform 3 actions: 1) call up to 10 contacts previously added; 2) transmit a text message stating “I'M IN TROUBLE. PLEASE HELP.” to all contacts; and 3) transmit a text message including a drop pin with a user current location.

Mobile application 300 comprises module 312, which when held for 3 seconds will perform 2 actions: 1) call a lawyer or a paralegal using face time and 2) save the entire call into a cloud storage.

Mobile application 300 comprises module 313, which plays in a loop clickable ads or announcements via RSS feed.

Mobile application 300 comprises module 314, which enables the user to open Facebook, Instagram, and Twitter applications via the live video upload, generally though a one click capability (click upload live).

Mobile application 300 comprises a database platform 315, wherein a user's information can be stored, such as a user's medical card. The medical card may include the user's medical information such as allergies, blood type, current medical conditions, copy of driver's license, passport, gun permit, etc.

Mobile application 300 comprises vault 316, wherein a password protected page is accessed via vault 316, and wherein the password protected page stores selected documents, videos, and pictures. Vault 316 can access the camera, video of the device and has scanning capabilities.

Mobile application 300 comprises a locator function 317, which facilitates the user to identify sex offenders and/or other registered criminals in a determined location. Locator 317 may open a webpage such as https://www.familywatchdog.ug/showmap.asp.

Mobile application 300 comprises module 318, which facilitates the user to access extra paid services from a specialist, such as background checks.

Mobile application 300 comprises module 319, which facilitates the user to lookup an inmate via a webpage such as http://inmateinfo.indy.gov/IML or http://.mycase.com. Module 319 also facilitates the user to access local contracted bailbonds on call.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method for establishing real-time wirelessly communication with a professional representative, the method comprising:
receiving an acceptance signal from a first personal computing device of at least a second personal computing device, through one or more processors;
accessing a registration database to determine at least the second personal computing device from at least one professional representative registered in the registration database;
detecting at least the second personal computing device; and
generating an activation request signal for transmission from at least the second personal computing device to the at least one personal computing device.

2. A method as in claim 1, wherein the acceptance signal receives a response from at least one professional representative computing device comprising the exchange of wireless communicating information between the at least one professional representative computing device and the first personal computing device.

3. A method as in claim 1, wherein the professional representative is a legal representative.

4. A method as in claim 1, wherein the one or more processors are configured to wirelessly communicate the first personal computing device with at least the second personal computing device.

5. A system comprising:
one or more processors; and
one or more data storage media operatively connected to the one or more processors, the one or more data storage media storing a registration database and program instructions accessible by the one or more processors,
wherein, the one or more processors are configured to:
access the registration database responsive to receiving to detect that at least one of the one or more personal computing devices is located proximate to a professional representative;
generate an activation request signal for transmission to the at least one personal computing device proximate to a real-time virtual professional representative; and
respond to receiving an acceptance signal from a first personal computing device of the at least one personal computing device proximate to wirelessly communicate with said first personal computing device.

6. A system as in claim 5, wherein the professional representative is a legal representative.

7. A method comprising:
pressing a first module in a mobile application for a determined period of time, wherein the first module automatically initiates a call to emergency services; and
pressing a second module in the mobile application for a predetermined period of time, wherein the second module automatically performs at least two predetermined actions.

8. A method as in claim 5, wherein the predetermined period of time is three seconds.

9. A method as in claim 5, wherein the at least two predetermined actions are selected from the group consisting of: automatically call a plurality of pre-selected contacts, transmit a text message containing a predetermined text body to at least one pre-selected contact, transmit a text message including a drop pin with a user's current location to at least one pre-selected contact, automatically call a legal representative.
